(19) United States
(12) Patent Application Publication
(10) Pub. No.: US 2008/0101579 A1
(43) Pub. Date: May 1, 2008

(54) Telephone system, master device, and terminal accommodation method

(75) Inventor: Hitoshi Kato, Sagamihara-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/976,816

(22) Filed: Oct. 29, 2007

(30) Foreign Application Priority Data
Oct. 31, 2006 (JP) 2006-296922

(51) Int. Cl. H04M 3/42

(52) U.S. Cl. 379/212.01

(57) ABSTRACT

According to one embodiment, a telephone system including a first communication terminal configured to perform a telephone communication by use of proper address information, a master device which accommodates the first communication terminal via an extension telephone network, and a second communication terminal configured to perform a telephone communication by use of proper address information different from that of the first communication terminal, wherein, in the case where an extension number of the first communication terminal and that of the second communication terminals are the same with each other, the master device, when receiving a connection request from the second communication terminal, distinguishes the first communication terminal from the second communication terminal by using the address information proper to these communication terminals, and accommodates the second communication terminal via the extension telephone network.

### CROSS-REFERENCE TO RELATED APPLICATIONS

This application is based upon and claims the benefit of priority from Japanese Patent Application No. 2006-296922, filed Oct. 31, 2006, the entire contents of which are incorporated herein by reference.

### BACKGROUND

1. Field

One embodiment of the invention relates to a telephone system to be used as a private extension telephone system, etc., its master device and a terminal accommodation method. More specifically, the present invention relates to an improvement in a system of combining a key telephone system and an Internet Protocol (IP) telephone terminal.

2. Description of the Related Art

In telephone systems of recent years, Voice over Internet Protocol (VoIP), by which voice communication is effected over an IP network, has entered the mainstream. Some of this kind of systems has a login/logout function which is similar to that of a personal computer. Under this function, on logging into the telephone system from a telephone terminal, a user becomes able to use the terminal as a user's private terminal regardless of the place where the terminal is. In other words, the user may utilize personalized setting of a button function, telephone book data for private use, etc., without being worried about the place where the user is.

Meanwhile, it is well known that telephone numbers have outside line numbers and extension numbers made distinct from one another. Since the outside line numbers among them are uniquely managed for each terminal, identical numbers are not assigned to a plurality of terminals. However, in the extension numbers, identical numbers are assigned to a plurality of terminals sometimes.

For example, if it is supposed that extension numbers are uniquely managed in an office X, there are some cases in which the same extension number as that of a terminal XT of office X is assigned to a certain terminal (let the certain terminal be terminal YT) in an office Y which has logged into the server of office X via an external network. That is, the case where terminal XT has extension number 3000, and terminal YT has extension number 3000 is a possible case. Although the IP telephone system having the aforementioned login/logout function also has a variety of convenient functions, such competition between extension numbers possibly occurs.

To cope with such a situation, most of the existing systems reject login from a terminal having an identical telephone number. Exceptionally, a technique disclosed in Jpn. Pat. Appln. KOKAI Publication 2006-157516 has been proposed. This reference discloses a technique of giving a priority to the posterior login from a terminal BB having the same telephone number as that of a terminal AA which has logged in earlier, and releasing registration of terminal AA with the system. This technique is a so-called last-in first-out processing system, and in a view point from the system, there is only one terminal having the identical telephone number.

As described above, the existing telephone system cannot construct such a state that a plurality of terminals having the identical telephone numbers (extension numbers) are registered in the system. The possibility of constructing such a state further improves the convenience of the user.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary system view illustrating an embodiment of a telephone system regarding the invention;

FIG. 2 is an exemplary schematic view illustrating an extension number-IP address correspondence table 100d;

FIG. 3 is an exemplary function block diagram illustrating an embodiment of a key telephone device 10;

FIG. 4 is an exemplary flowchart illustrating a processing procedure of basic operations in the system of FIG. 1;

FIG. 5 is an exemplary schematic view illustrating processing when an incoming call from another terminal is received;

FIG. 6 is an exemplary schematic view illustrating processing in responding to a call arrival in the system of FIG. 1; and

FIG. 7 is an exemplary flowchart illustrating a processing procedure in transmitting/receiving a call and in responding to a call in the system of FIG. 1.

### DETAILED DESCRIPTION

Various embodiments according to the invention will be described hereinafter with reference to the accompanying drawings. In general, according to one embodiment of the invention, a telephone system comprising: a first communication terminal configured to perform a telephone communication by use of proper address information; a master device which accommodates the first communication terminal via an extension telephone terminal; and a second communication terminal configured to perform a telephone communication by use of proper address information different from that of the first communication terminal, wherein, in the case where the first and the second communication terminals are the same with each other, the master device, when receiving a connection request from the second communication terminal, distinguishes the first communication terminal from the second communication terminal by using the address information proper to these communication terminals, and accommodates the second communication terminal via the extension telephone network.

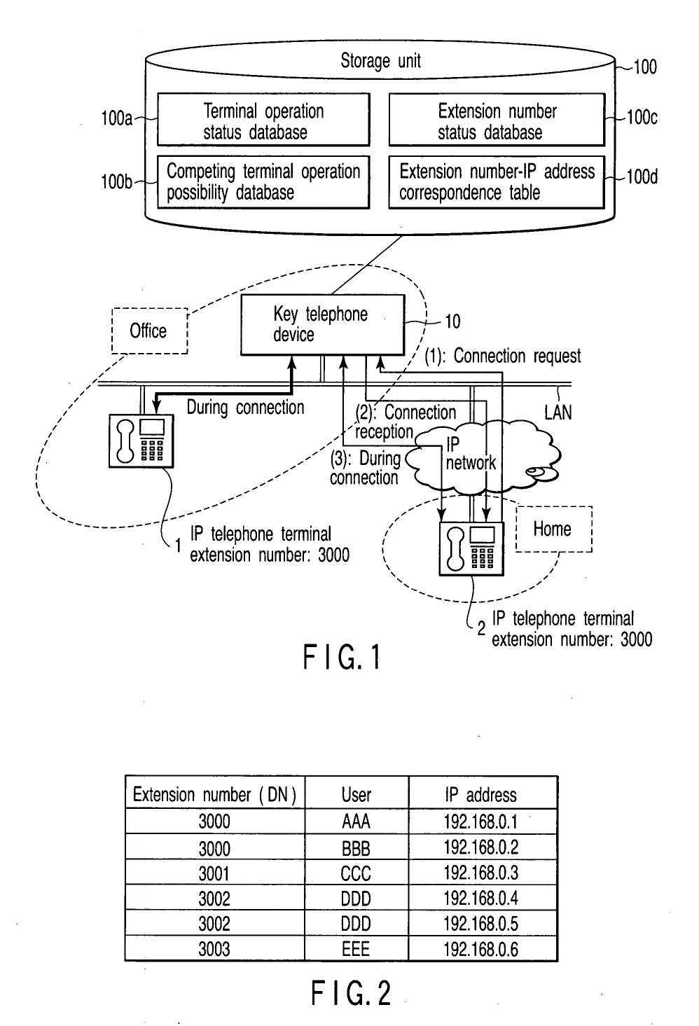

According to an embodiment, FIG. 1 is a system view depicting an embodiment of a telephone system concerning the invention. The system depicted in FIG. 1 includes a key telephone device 10 to accommodate an IP telephone terminal 1 via a local area network (LAN); and an IP telephone terminal 2 belonging to an IP network. The LAN is connected to the IP network; thereby it is possible to form a connection between the key telephone device 10 and telephone terminal 2. The LAN and telephone terminal 1 form an extension network within an office, and telephone terminal 2 is installed in a user's home, etc. Both IP telephone terminals 1 and 2 have telephone communication functions, the system being referred to as Voice over Internet Protocol (VoIP), performing telephone communication by means of Internet Protocol (IP). Therefore, telephone terminals 1 and 2 have each a proper IP address, respectively. The key telephone device 10 has, for example, a function of processing Session Initiation Protocol (SIP), and performs processing such as outgoing call processing, incoming call processing, and processing of transfer, etc., based on the IP address.

In FIG. 1, the key telephone device 10 includes a storage unit 100. The storage unit 100 stores a terminal operation status database 100a; a competing terminal operability database 100b; an extension number status database 100c; and an extension number-IP address correspondence table 100d. The status database 100a is used to manage the operating states of telephone terminal 1, telephone terminal 2, and other telephone terminals (not depicted). The possibility database 100b is used to manage the possibility of simultaneous operation of telephone terminals having identical extension numbers. The status database 100c is utilized to manage the extension numbers to be used in the system.

FIG. 2 is a schematic view illustrating the correspondence table 100d. This table 100d is one in which the extension numbers to be used in the system are associated with IP addresses added to the IP telephone terminals each having the extension numbers. The correspondence table 100d in FIG. 2 shows the names, or identifications (IDs) of the users of the respective IP telephone terminals.

In FIG. 1, telephone terminal 1 and telephone terminal 2 mutually have identical extension numbers (directory number: DN) 3000. According to the correspondence table 100d, the users of terminals 1 and 2 are AAA and BBB, respectively, and the IP addresses are 192.168.0.1 and 192.168.0.2, respectively.

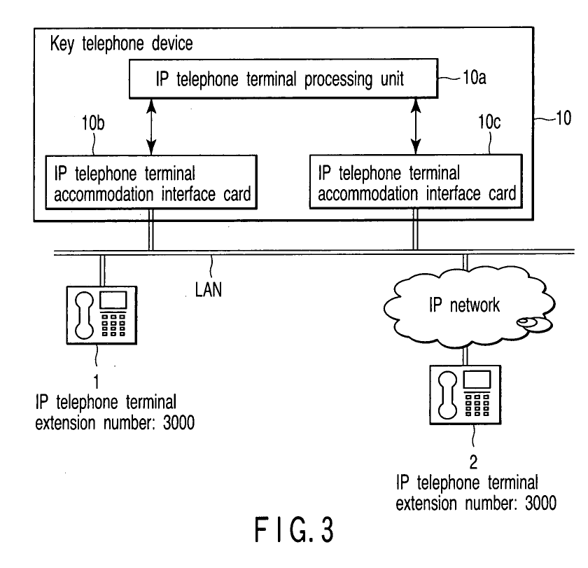

FIG. 3 is a function block diagram showing the embodiment of the key telephone device 10. The telephone device 10 includes IP telephone terminal accommodation interface cards 10b and 10c which are connected to the LAN, and an IP telephone terminal processing unit 10a which processes operations of the IP telephone terminals through the cards 10b and 10c. In FIG. 3, although different interface cards 10b and 10c accommodate terminal 1 and terminal 2, respectively, the identical interface card may accommodate a plurality of telephone terminals.

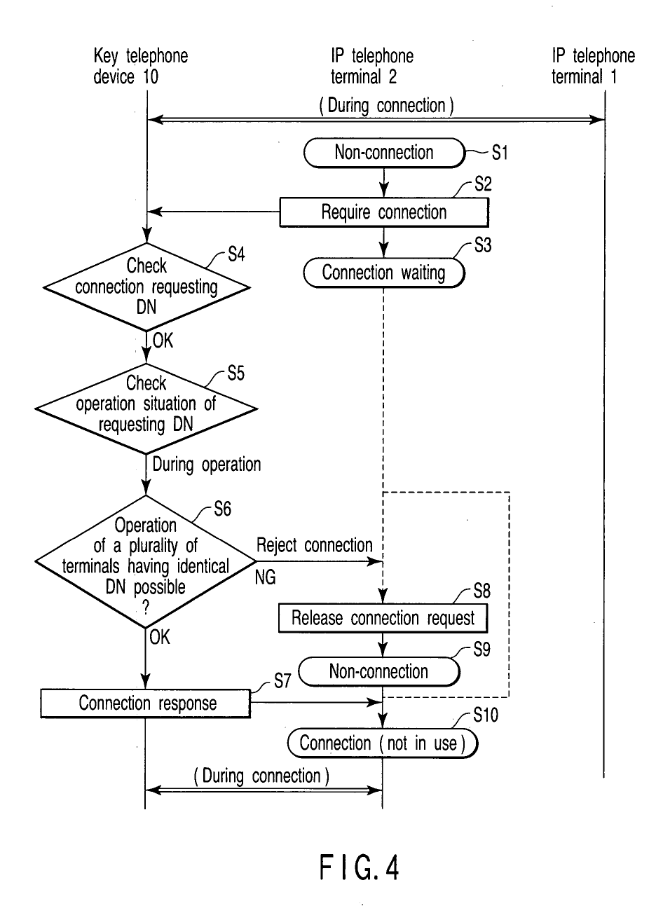

FIG. 4 is a flowchart showing a processing procedure of basic operations in the system of FIG. 1. In FIG. 4, at first, it is presumed that terminal 1 is contained and connected in and to the telephone device 10. And terminal 2 is in non-connection to the telephone device 10 (block S1). When the connection request ((1) in FIG. 1) from telephone terminal 2 arrives at the telephone device 10 from such a state in block S1 (block S2), the telephone device 10 receives the connection request from terminal 2 through the interface card 10c. Terminal 2 is brought into a state of waiting for the connection (block S3).

The telephone device 10 confirms a situation of the same DN 3000 as DN 3000 which has already being in connection by means of the status database 100c (blocks S4, S5). If DN 3000 is in operation, the telephone device 10 refers to the possibility database 100b to confirm the setting situation of DN 3000 (block S6).

If the possibility of operations is in affirmative (OK, in block S6), the telephone device 10 replies a connection acceptance ((2) of FIG. 1) as a response to the connection request for the telephone device 10, and registers the existence of two telephone terminals 1 and 2 as the IP telephone terminals each having DN 3000 in the status database 100a. When receiving the connection response, terminal 2 becomes in connection (3) with the telephone device 10.

If the possibility of the operations is not in affirmative (NG, in block S6), the telephone device 10 replies the connection rejection response to terminal 2. Thereby, the connection request is released (block S8), the non-connection state of terminal 2 to the telephone device 10 lasts (blocks S9, S10)

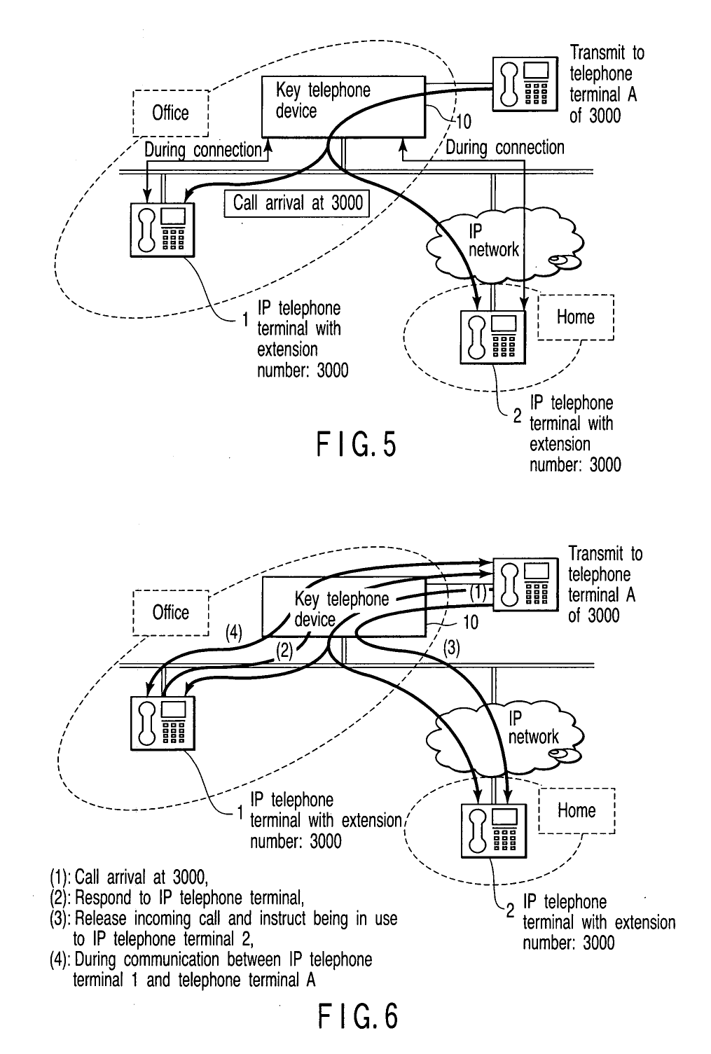

FIG. 5 is a schematic view showing processing when a call arrival from another terminal occurs in the system of FIG. 1. FIG. 7 is a flowchart showing a processing procedure in outgoing/incoming call and in responding to a call in the system of FIG. 1. A doted line frame A corresponds to FIG. 5. In blocks S11, S28 and S32 of FIG. 7, it is supposed that the extension 3000 is not busy, and both connections to IP telephone terminals 1 and 2 are not busy. From this state, when the user of telephone terminal A makes a call to DN 3000, the transmission request to DN 3000 is sent from telephone terminal A to the key telephone device 10.

The telephone device 10 determines that the reception is the termination of the incoming call to DN 3000, the processing unit 10a performs call arrival analysis for DN 3000 (block S12). In block S12, the system obtains the state of DN 3000 from the status database 100c, and if DN 3000 is not busy, the system obtains the IP telephone terminal having the extension number of DN 3000 from the state database 100a. As a result, the system can obtain terminals 1 and 2.

The telephone device 10 terminates call arrivals to terminals 1 and 2 obtained from the databases (blocks S13, S14). Both terminals 1 and 2 which have received the incoming calls from the telephone device 10 are brought into states of being in call arrival (blocks S29, S33).

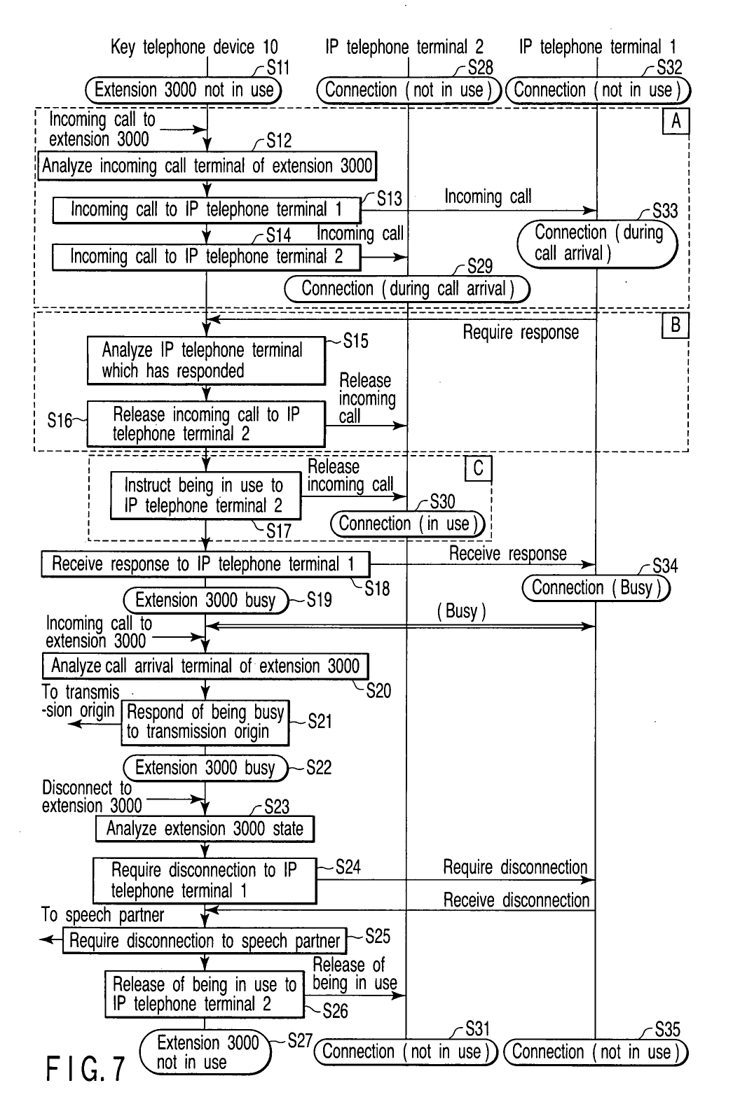

FIG. 6 is a schematic view showing processing in a call arrival response in the system of FIG. 1. Here, FIG. 6 illustrates the case in which terminal 1 has responded to a call arrival. Dotted line frames B and C in FIG. 7 correspond to FIG. 6. In FIG. 7, terminal 1 sends a response request for a call arrival to the telephone device 10. The device 10 analyzes the response request to recognize the fact that terminal 1 has made a response (block S15). The key telephone device 10 conducts call arrival release to terminal 2, further issues an instruction of being in use (blocks S16 and 17).

Terminal 2 receives the call arrival release, and releases the call arrival. Terminal 2 further receives the instruction of being in use, and results in the state of being in use (block S30). The key telephone device 10 sends a response to telephone terminal A and a response reception to telephone terminal 1, respectively (block S18). Telephone terminal 1 which has received the response reception becomes in communication with telephone terminal A (block S34). The telephone device 10 makes the state of DN 3000 of the status database 100c be busy (block S19). Making terminal 2 be in use in accordance with the aforementioned procedure restricts the transmission from terminal 2.

In succession, a processing procedure after the state of the communication between terminal 1 and terminal A will be described. During communication, when a new incoming call destined to DN 3000 arrives at the key telephone device 10, the key telephone device 10 requests the state of DN 3000 from the status database 100c in the call arrival analysis. As the state is one being busy, the key telephone device 10 replies the response indicating the state of being busy to the outgoing call origin (blocks S20, S21).

Successively, the procedure of the case in which a disconnection request from terminal A is made will be described. The telephone device 10 which has received the disconnection request from terminal A, after analyzing the state of DN 3000 (block S23), transmits the disconnection request to terminal 1 (block S24). Terminal 1 which has received the disconnection request replies the disconnection reception to the telephone device 10 and attains a not busy state (block S35).

The telephone device 10 which has received the disconnection response disconnects terminal A and issues an instruction of release of being in use to terminal 2 (blocks S25, S26). Terminal 2 which has received the instruction of use release attains a state of being not busy. The key telephone device 10 makes the state of DN 3000 of the extension number status database 100c be not busy (blocks S27, S31).

As described above, in the embodiment, when a connection is required from another IP telephone terminal 2 having the same extension number (3000) as that of IP telephone terminal 1 being in connection with the key telephone device 10, the system distinguishes these terminals 1 and 2 based on the IP addresses, and allows the connection from terminal 2. Thereby, it becomes able to operate the identical extension numbers at a plurality of places. When one IP telephone terminal having the identical extension number is in use due to being busy, it becomes able to restrict the use of other IP telephone terminals then it becomes able to avoid wrong use by other users.

To summarize the description given above, the embodiment produces the following effects:

(a) The telephone system becomes able to allow the operation for the IP telephone terminal which has been connected to the key telephone device from another location, etc., by using the same extension number as that of the IP telephone terminal which has been connected to the telephone device and has been in use, and the system makes it possible to simultaneously use a plurality of IP telephone terminals having identical extension numbers.

(b) The system becomes able to accommodate the plurality of telephone terminals having identical extension numbers, and when an incoming is terminated to the extension number, the incoming call becomes able to be terminated to all IP telephone terminals having identical extension numbers.

(c) The system becomes able to release the arrivals of the incoming calls to other IP telephone terminals having identical extension numbers when one of the IP telephone terminals having the identical extension number made the response to the call arrival.

(d) The system becomes able to restrict the use from other IP telephone terminals having identical extension numbers during communication of the IP telephone terminals having identical extension numbers.

According to these facts, the invention becomes able to provide a telephone system which enables simultaneously using a plurality of terminals having identical telephone numbers, and its master device, and a terminal accommodation method.

The invention is not limited to foregoing embodiments as they are. For example, in FIGS. 6 and 7, while the embodiment has been described about the example to conduct the disconnection from telephone terminal A, the same procedure goes in the case that the disconnection is made from IP telephone terminal 1. Although FIG. 1 illustrates the form in which IP telephone terminal 2 belongs to a network different from that to which IP telephone terminal 1 belongs, IP telephone terminals 1 and 2 may belong to the same extension telephone network.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as world fall within the scope and spirit of the inventions.

What is claimed is:

1. A telephone system comprising:
a first communication terminal configured to perform a telephone communication by use of proper address information;
a master device which accommodates the first communication terminal via an extension telephone network; and
a second communication terminal configured to perform a telephone communication by use of proper address information different from that of the first communication terminal, wherein
in the case where an extension number of the first communication terminal and that of the second communication terminals are the same with each other,
the master device, when receiving a connection request from the second communication terminal, distinguishes the first communication terminal from the second communication terminal by using the address information proper to these communication terminals, and accommodates the second communication terminal via the extension telephone network.

2. The telephone system according to claim 1, wherein the master device terminates an incoming call generated for the extension number to the first and the second communication terminals.

3. The telephone system according to claim 2, wherein the master device releases an incoming call to a communication terminal which has not responded to the incoming call when either the first or the second communication terminal responds to the incoming call.

4. The telephone system according to claim 1, wherein the master device restricts use of a communication terminal which is not in busy in a state where either the first or the second communication terminal is busy.

5. A master device, accommodating a first communication terminal configured to perform a telephone communication by using proper address information via an extension telephone network, wherein
the master device distinguishes the first communication terminal from the second communication terminal by using the address information proper to these communication terminals, and accommodates the second communication terminal via the extension telephone network when receiving a connection request from the second communication terminal configured to perform a telephone communication by using proper address information different from that of the first communication terminal and have the same extension number as that of the first communication terminal.

6. The master device according to claim 5, which terminates an incoming call generated for the extension number to the first and the second communication terminals.

7. The master device according to claim 6, which releases an incoming call to a communication terminal which has not responded to the incoming call when either the first or the second communication terminal responds to the incoming call.

8. The master device according to claim 5, which restricts use of a communication terminal which is not in busy in a state where either the first or the second communication terminal is busy.

9. A terminal accommodation method for use in a telephone system, including a first communication terminal configured to perform a telephone communication by using proper address information; a master device which accommodates the first communication terminal via an extension telephone network; and a second communication terminal configured to perform a telephone communication by using proper address information different from that of the first communication terminal, wherein, in the case that an extension number of the first communication terminal and that of the second communication terminals are the same with each other,
distinguishing the first communication terminal from the second communication terminal by using the address information proper to these communication terminals when receiving a connection request from the second communication terminal by the master device; and
accommodating the second communication terminal via the extension telephone network.

10. The accommodation method according to claim 9, further comprising: terminating an incoming call generated for the extension number to the first and the second communication terminals.

11. The accommodation method according to claim 10, further comprising: releasing an incoming call to a communication terminal which has not responded to the incoming call when either the first or the second communication terminal has responded to the incoming call.

12. The accommodation method according to claim 9, further comprising: restricting use of a communication terminal which is not in busy in a state where either the first or the second communication terminal is busy.
